(19) United States
(12) Patent Application Publication
(10) Pub. No.: US 2018/0120690 A1
(43) Pub. Date: May 3, 2018

(54) Photoactive Solution Systems and Methods for Photochromic Liquids and Photoconductive Liquids

(71) Applicant: The United States of America as represented by the Secretary of the Navy, San Diego, CA (US)

(72) Inventors: Carol A. Becker, Del Mar, CA (US); Wayne E. Glad, Del Mar, CA (US)

(21) Appl. No.: 15/340,207

(22) Filed: Nov. 1, 2016

(51) Int. Cl. G03C 1/73; G03C 5/56; G03C 5/16

(52) U.S. Cl. CPC G03C 1/73; G03C 5/56; G03C 2200/43; G03C 2005/166; G03C 2200/42; G03C 5/16

(57) ABSTRACT

A photoactive solution system for at least one of photochromic liquids and photoconductive liquids, involving a protonating solvent, comprising at least one of a first solvent and a second solvent, and an anthracene-derivative solute configured to dissolve in the protonating solvent, whereby a photoactive solution is responsive to light having a wavelength in at least one of a visible spectrum, a near-ultraviolet spectrum, and an ultraviolet spectrum, and whereby a photoactive response is elicitable.

### FEDERALLY-SPONSORED RESEARCH AND DEVELOPMENT

The United States Government has ownership rights in the subject matter of the present disclosure. Licensing inquiries may be directed to Office of Research and Technical Applications, Space and Naval Warfare Systems Center, Pacific, Code 72120, San Diego, Calif., 92152; telephone (619) 553-5118; email: ssc_pac_t2@navy.mil. Reference Navy Case No. 102745.

### BACKGROUND OF THE INVENTION

### Technical Field

The present disclosure technically relates to photoactive materials. Particularly, the present disclosure technically relates to photoactive materials capable of changing light absorption characteristics when irradiated by light of a different wavelength.

### Description of Related Art

In the related art, some substances are capable of changing light absorption characteristics when irradiated by light of a different wavelength. This change is called photochromism; and the change occurs through a variety of photochemical mechanisms. Photochromism is a reversible change in the light absorption properties of a substance, such as a photochromic compound, when the substance is irradiated with light of a wavelength different than the original excitation wavelength. Typically, irradiation with ultraviolet (UV) light will cause a photochromic substance to absorb visible light and become colored. The radiating light can be either monochromatic or polychromatic. When the irradiating light is removed, the substance returns to a colorless state. These photochromic compounds have applications in a variety of fields, the most well-known being eyeglasses that darken outdoors, e.g., in the UV and visible spectrum of the sun, and return to a transparent state indoors. Other uses involve UV-driven filters, e.g., optical switches, display elements, or optical recording media. One such optical switch can take the form of a liquid-filled fiber-optic component.

Referring to FIG. 1, this table lists some photochromic reaction mechanisms, and corresponding compound types which react via these mechanisms, in accordance with the related art. These molecules relax back to the colorless form at different rates depending on the chemistry involved. In general, the back reaction rates are not externally adjustable. For example, in an article “A Fast Photochromic Molecule that Colors Only under UV Light” by Kishimoto et al., J. Am. Chem. Soc., 2009, 131(12), pp. 4227-4229, a dissociation process leads to radical pairs which recombine to form the parent molecule with a lifetime of tens of milliseconds at room temperature. In another example, the Applicants' U.S. Pat. No. 7,655,115 involves a solute-solvent solution that allows the solute to become photo-protonated by the solvent on absorption of ultraviolet light. The solute is 1,2,3,4,5,6,7,8-octamethylanthracene (OMA). The solvent is 1,1,1,3,3,3-hexafluoro-2-propanol (HFIP).

In the related art, back reaction rates or relaxation rates are not externally adjustable. Therefore, a need exists in the related art for the development of further photochromic materials having relaxation rates suitable for particular applications.

### BRIEF SUMMARY OF INVENTION

To address at least the needs in the related art, the present disclosure involves a photoactive solution system for at least one of photochromic liquids and photoconductive liquids, comprising: a protonating solvent comprising at least one of a first solvent and a second solvent; and an anthracene-derivative solute configured to dissolve in the protonating solvent, whereby a photoactive solution is responsive to light having a wavelength in at least one of a visible spectrum, a near-ultraviolet spectrum, and an ultraviolet spectrum, and whereby a photoactive response is elicitable, in accordance with an embodiment of the present disclosure.

### BRIEF DESCRIPTION OF THE DRAWING

The above, and other, aspects and features, of several embodiments of the present disclosure are further understood from the following Detailed Description as presented in conjunction with the following several figures of the Drawing.

FIG. 1 is a table illustrating some photochromic reaction mechanisms with corresponding representative compound types, in accordance with the related art.

FIG. 2 is a diagram illustrating the protonation of anthracene, such as in a photoactive system, in accordance with an embodiment of the present disclosure.

FIG. 3 is a diagram illustrating elicitation of a photoactive response by way of a photoactive solution system, in accordance with an embodiment of the present disclosure.

FIG. 4A is a graphical diagram illustrating respective near-UV absorption spectra of non-protonated anthracene in cyclohexane and non-protonated 2,3,6,7-tetramethyanthracene in 1,1,1,3,3,3-hexafluoro-2-propanol (HFIP), in accordance with embodiments of the present disclosure.

FIG. 4B is a schematic diagram illustrating a transient absorption apparatus, by example only, using a photoactive solution system for at least one of a photochromic liquid and a photoconductive liquid, in accordance with embodiments of the present disclosure.

FIG. 5 is a molecular diagram illustrating a numbering system for nomenclature corresponding to substituted anthracene compounds, in accordance with various embodiments of the present disclosure.

FIG. 6A is a graphical diagram illustrating UV-visible absorption spectra of ground-state protonated anthracene in a BF₃/TFA solvent and a transient anthracene in an HFIP solvent, in accordance with embodiments of the present disclosure.

FIG. 6B is a graphical diagram illustrating the transient response of anthracene in an HFIP solvent, wherein the lifetime is determined using an exponential fit to the scope data, in accordance with embodiments of the present invention.

FIG. 7 is a diagram illustrating UV-visible absorption spectra of a ground-state protonated anthracene in a BF₃/TFA solvent and a transient anthracene in a TFA solvent, in accordance with embodiments of the present disclosure.

FIG. 8 is a diagram illustrating UV-visible absorption spectra of a ground-state protonated 9-methylanthracene in an H₂SO₄ solvent and a transient 9-methylanthracene in an HFIP solvent, in accordance with embodiments of the present disclosure.

FIG. 9 is a diagram illustrating UV-visible absorption spectra of a ground-state protonated 9-methylanthracene in an H₂SO₄ solvent and a transient 9-methylanthracene in a TFA solvent, in accordance with embodiments of the present disclosure.

FIG. 10 is a diagram illustrating UV-visible absorption spectra of a ground-state protonated 9,10-dimethylanthracene in a H₂SO₄ solvent and a transient 9,10-dimethylanthracene in an HFIP solvent, in accordance with embodiments of the present disclosure.

FIG. 11 is a diagram illustrating UV-visible absorption spectra of a ground-state protonated 9,10-dimethylanthracene in a H₂SO₄ solvent and a transient 9,10-dimethylanthracene in a TFA solvent, in accordance with embodiments of the present disclosure.

FIG. 12 is a diagram illustrating UV-visible absorption spectra of a ground-state protonated 2,3,6,7-tetramethyanthracene in an H₂SO₄ solvent and a transient 2,3,6,7-tetramethyanthracene in an HFIP solvent, in accordance with embodiments of the present disclosure.

FIG. 13 is a diagram illustrating UV-visible absorption spectra of a ground-state protonated 2,3,6,7-tetramethyanthracene in a H₂SO₄ solvent and a transient 2,3,6,7-tetramethyanthracene in a TFA solvent, in accordance with embodiments of the present disclosure.

FIG. 14 is a diagram illustrating UV-visible absorption spectra of a ground-state protonated 1,2,4,5,6,8-hexamethylanthracene in a TFA solvent and a transient 1,2,4,5,6,8-hexamethylanthracene in an HFIP solvent, in accordance with embodiments of the present disclosure.

FIG. 15 is a table illustrating various measurements, such as the wavelength at the maximum transient absorption, transient lifetime in HFIP, and transient lifetime in TFA, in relation to five anthracene or substituted anthracene molecules, by example only, in accordance with various embodiments of the present disclosure.

FIG. 16 is a graphical diagram illustrating the change in lifetime of protonated TMA by way of using acid additions, such as dilute TFA in HFIP additions, in accordance with embodiments of the present disclosure.

FIG. 17 is a schematic diagram illustrating a photoactive solution system for at least one of a photochromic liquid and a photoconductive liquid, in accordance with an embodiment of the present disclosure.

FIG. 18 is a flow diagram illustrating a method of preparing a photoactive solution system for at least one of a photochromic liquid and a photoconductive liquid, in accordance with an embodiment of the present disclosure.

FIG. 19 is a flow diagram illustrating a method of eliciting a photoactive response by way of a photoactive solution system for at least one of a photochromic liquid and a photoconductive liquid, in accordance with an embodiment of the present disclosure.

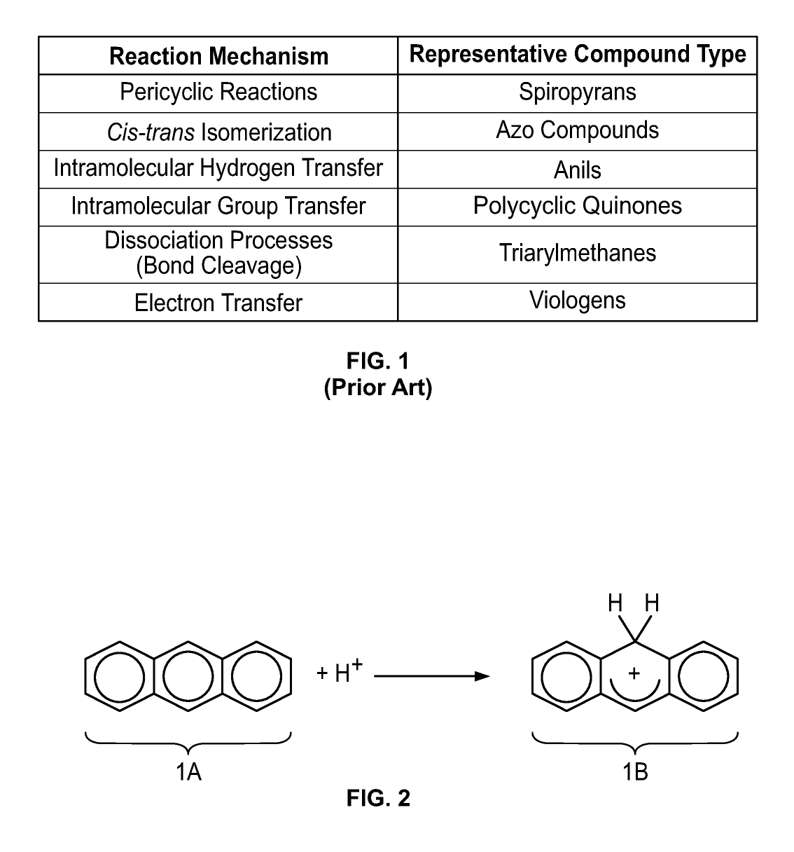

Corresponding reference numerals or characters indicate corresponding components throughout the several figures of the Drawing. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood, elements that are useful or necessary in commercially feasible embodiment are often not depicted in order to facilitate a less obstructed view of these various embodiments of the present disclosure.

### DETAILED DESCRIPTION OF THE EMBODIMENT(S)

The photoactive solution systems and methods involve formulations that use particular compounds having specific molecular structures, e.g., by way of formulated photoactive solution systems, for obtaining a variety of different relaxation rates or a variety of different relaxation lifetimes for a variety of different applications. Obtaining a different relaxation rate usually requires formulation of a solution system that uses a molecule with a modified structure. Different relaxation lifetimes may be required for different applications. For example, the systems and methods of the present disclosure provide a relaxation lifetime on the order of a second for achieving a steady state coloration in a low light flux environment, such as sunlight, and a much shorter relaxation lifetime for optical switching devices, such as for use in communications, telecommunications, optical display elements, optical recording media, and tunable wavelength filters. For example, the systems and methods of the present disclosure are useful for an optical switch, e.g., in the form of a liquid-filled fiber-optic component.

In general, the present disclosure involves systems and methods using formulated photoactive solutions comprising a class of molecules, such as anthracene and methyl-substituted derivatives thereof, configured to photo-protonate by way of light in at least one of a near-ultraviolet, an ultra-violet spectrum, and a visible spectrum, and to be responsive by providing a colored light, e.g., in the visible spectrum. The methylanthracene compounds of the present disclosure are configured to provide the lifetime and charge conversion criteria desired for fast light modulation applications. In the embodiments of the present disclosure, all of the methylanthracene compounds are configured to absorb light in the near-ultraviolet region of the spectrum, such as between approximately 300 and approximately 400 nanometers, and are configured to become photochromic in the visible region of the spectrum. By example only, the photoactive solution systems and methods of the present disclosure involve an adjustable short-lived photo-protonation and deprotonation by way of carbo-cation, whereby a photoactive or photochromic response is elicitable, and whereby the photoactive or photochromic response is tunable.

In particular, the photoactive solution systems and methods of the present disclosure incorporate particular solutes configured to rapidly photo-protonate with ultraviolet light, e.g., in the near-UV region, and to slowly deprotonate in the ground state. The protonated form of these particular solutes absorbs visible light. Hence, the solution systems of the present disclosure are photoactive, e.g., photochromic or photoconductive, for at least that these solution systems absorb light of a wavelength distinct from that at which these solution systems are excited. The protonation reaction also increases the electrical conductivity and the dielectric constant of the solution system. The lifetime of the protonated forms comprises a range of approximately 0.7 ms to approximately 670 ms as a function of the solute-and-solvent combination, in accordance with various embodiments of the present disclosure. A number of applications for the photoactive solution systems, e.g., photochromic liquids, are described herein.

With greater particularity, the photoactive solution systems and methods of the present disclosure involve a solute, such as an anthracene, e.g., a substituted anthracene (anthracene derivative), and a protonating solvent (two-part) comprising a first solvent, such as 1,1,1,3,3,3-hexafluoro-2-propanol, and a second solvent, such as trifluoroacetic acid, whereby lifetime of a protonated solution system comprises a range of approximately 4.7 ms to approximately 670 ms. For example, the solutes comprise at least one of anthracene, 9-methylanthracene, 9,10-dimethylanthracene, 2,3,6,7-tetramethylanthracene, and 1,2,4,5,6,8-hexamethylanthracene, in accordance with embodiments of the present disclosure. Controlled addition of acid facilitates adjustability of the photochromic activity, thereby tailoring or tuning the photoactive solution system to a specific application, e.g., for use in sensors or filters. Also, photochromic materials of the present disclosure are configured to return to the colorless state in a range of approximately a fraction of a millisecond to tens of milliseconds for video display uses.

In accordance with an embodiment of the present disclosure, a photoactive solution system responsive to ultraviolet light, comprises: a protonating solvent, the protonating solvent comprising a first solvent and a second solvent; and an anthracene-derivative (AD) solute configured to dissolve in the protonating solvent, whereby a photoactive solution is responsive to light having a wavelength in a visible spectrum, a near-ultraviolet spectrum, and an ultraviolet spectrum, and whereby a photoactive response is elicitable.

In accordance with an embodiment of the present disclosure, a method of preparing a photoactive solution system, comprises: providing a protonating solvent, providing the protonating solvent comprising: providing a first solvent; providing a second solvent; and admixing the second solvent with the first solvent; providing an anthracene-derivative (AD) solute; and dissolving the anthracene-derivative (AD) solute in the protonating solvent, thereby preparing a photoactive solution responsive to light having a wavelength in a visible spectrum, a near-ultraviolet spectrum, and an ultraviolet spectrum, and whereby a photoactive response is elicitable.

In accordance with an embodiment of the present disclosure, a method of eliciting a photoactive response by way of a photoactive solution system, comprises: providing a photoactive solution, providing the photoactive solution comprising: providing a protonating solvent, providing the protonating solvent comprising: providing a first solvent; providing a second solvent; and admixing the second solvent with the first solvent; providing an anthracene-derivative (AD) solute; and dissolving the anthracene-derivative (AD) solute in the protonating solvent, thereby preparing a photoactive solution responsive to light having a wavelength in a visible spectrum, a near-ultraviolet spectrum, and an ultraviolet spectrum; and irradiating the photoactive solution with ultraviolet light, thereby eliciting the photoactive response.

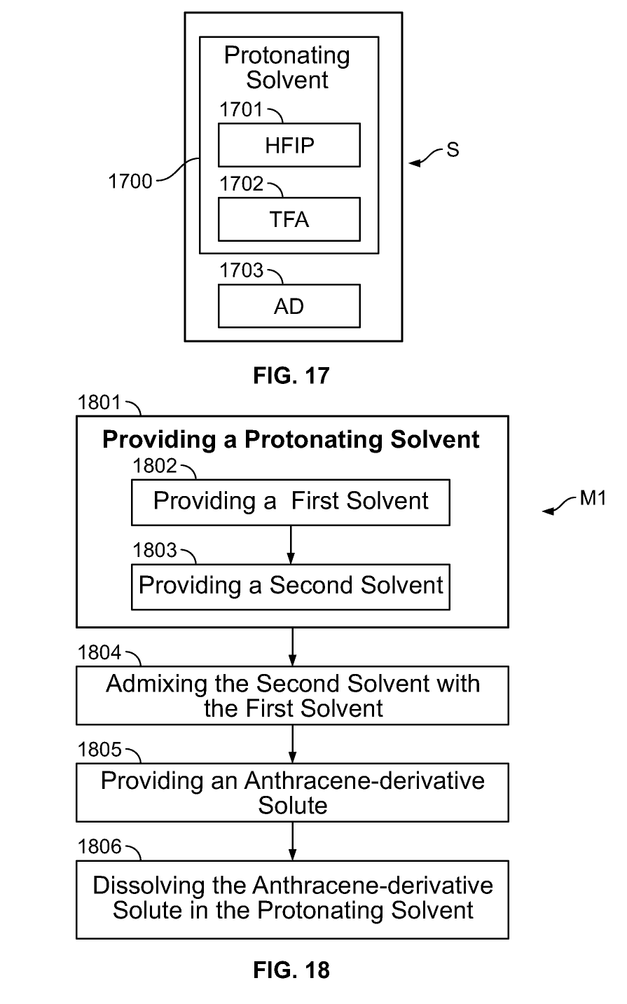

Referring to FIG. 2, this diagram illustrates the protonation of anthracene 1A, such as in a photoactive solution system S (FIG. 17), in general, in accordance with an embodiment of the present disclosure. In the photoactive solution system S, by example only, photochromism comprises a photo-protonation reaction. Photo-protonation is a reaction that involves transfer of a proton from the solvent to the excited state of the irradiated molecule. Equilibrium constants for protonation in excited states can differ from those in the ground state by as much as 29 orders of magnitude, allowing some molecules that are not very basic in their ground states to become significantly more basic in their excited states. By example only, anthracene in the ground state 1A is a very weak base which is only protonatable by a very strong acid, such as concentrated sulfuric acid, to give the protonated form 1B. The equilibrium constant (K_{b}) for the ground-state protonation of anthracene in water is approximately 10⁻¹⁴.

Still referring to FIG. 2, for at least that anthracene 1A comprises a different electronic structure in the first excited singlet state, the K_{b} for the protonation reaction in the first excited singlet state is approximately 10⁰, corresponding to an increase in basicity of 14 orders of magnitude. This basicity increase facilitates protonation in the excited state in solvents other than extremely strong acids, in accordance with an embodiment of the present disclosure. However, the lifetime of the excited singlet state, as measured by its fluorescence lifetime, is very short, e.g., on the order of nanoseconds. As a result, the protonation reaction must proceed quite quickly to compete with the decay of the excited state. The protonated form of the molecule has an absorption spectrum that is substantially different from that of the parent molecule; and the systems and methods of the present disclosure utilize this difference for a variety of applications.

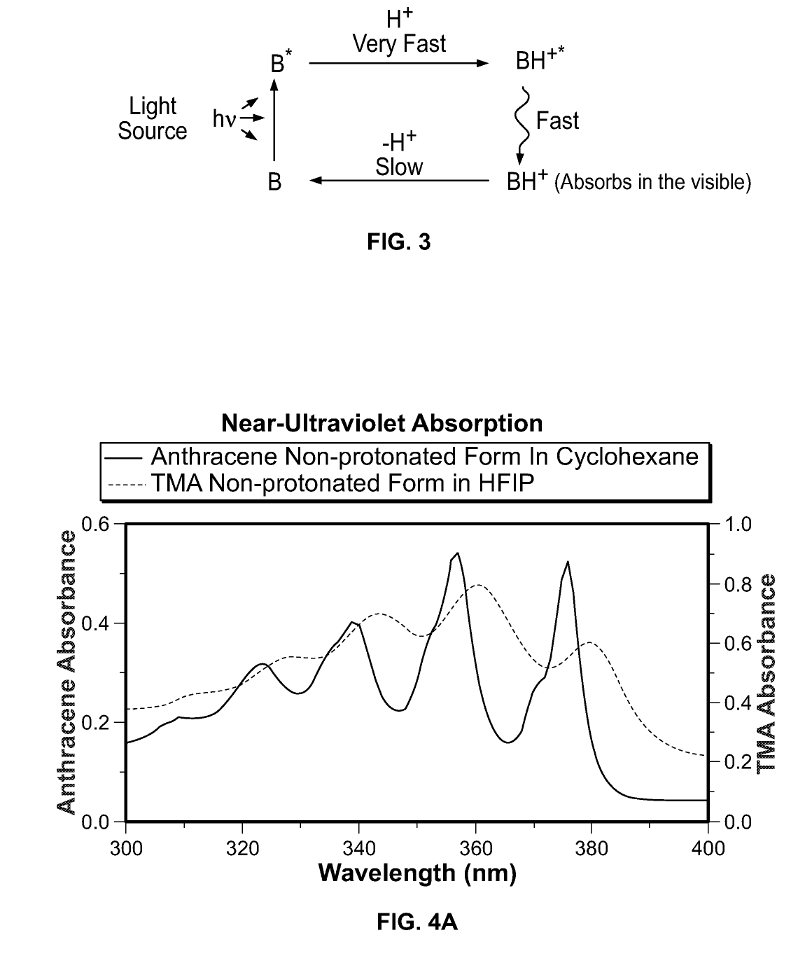

Referring to FIG. 3, this diagram illustrates elicitation of a photoactive response by way of a photoactive solution system S (FIG. 17), e.g., an excited state photo-protonation reaction, in accordance with an embodiment of the present disclosure. In response to photo-excitation of the photochromic molecule, such as the anthracene-derivative (AD) molecules of the present disclosure, in a ground-state B by a light source, such as an eximer laser pulsed at approximately 351 nm and within a power range of approximately 10 milli-Joules/pulse to approximately 150 milli-Joules/pulse, the photochromic molecule, being excited by an excitation beam, moves into an excited state B* and is very quickly protonated to an excited state BH⁺*, wherein the excited state BH⁺* decays quickly to the protonated ground state BH⁺ for at least that fluorescence from BH⁺* is not significantly observable. The photochromic molecule in the ground-state protonated form, e.g., in the state BH⁺, then decays relatively slowly back to the ground-state non-protonated form. Thus the formation and longevity of BH⁺ depend on rapid protonation in the excited state and relatively slow (milliseconds or longer) deprotonation in the ground state, such activity being encompassed by the present disclosure.

Still, referring to FIG. 3, the deprotonation rate in the ground state is a function of the solvent(s) used in the photo-protonation experiment. The first solvent, comprising 1,1,1,3,3,3-hexafluoro-2-propanol (HFIP), is weakly acidic (pKₐ=9.3), is a poor nucleophile, and is reluctant to be protonated itself due to the inductive effect of the fluorine atoms in the molecule. However, the first solvent, comprising HFIP, is a sufficiently strong acid for protonating aromatic compounds in the excited state and is extremely stabilizing to the ground-state protonated cation that is formed. The second solvent, comprising trifluoroacetic acid (TFA), is also a sufficiently strong acid for protonating aromatic compounds in the excited state, but lifetimes of ground-state protonated forms are somewhat shorter than those relating to HFIP. Protonated molecules of particular solutes, such as anthracene derivatives (AD), e.g., by a photo-protonation reaction, that absorb light in the visible range of the spectrum have been hitherto unknown or to perform in the manner as herein described.

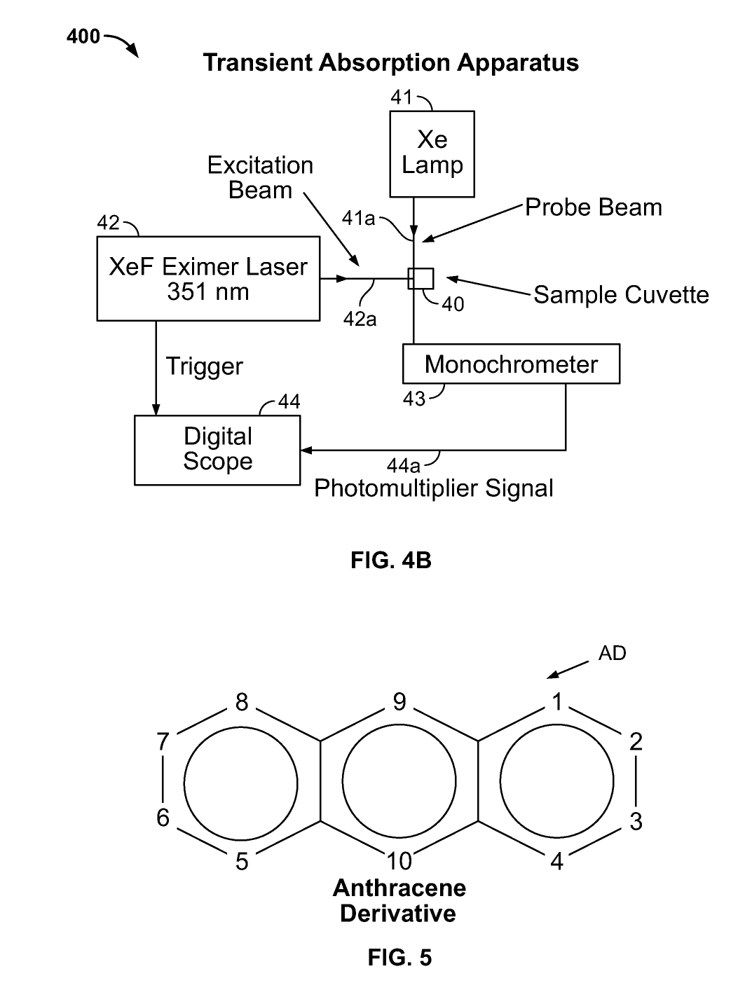

Referring to FIG. 4A, this graphical diagram illustrates respective near-UV absorption spectra of non-protonated anthracene in cyclohexane and non-protonated 2,3,6,7-tetramethyanthracene (TMA) in 1,1,1,3,3,3-hexafluoro-2-propanol (HFIP), wherein an abscissa axis represents wavelength of the incident light, and wherein an ordinate axes represent respective jump molecule absorbance, in accordance with embodiments of the present disclosure. This relationship also applies to a class of molecules, such as anthracene and its methylsubstituted derivatives, which can be photo-protonated with near-ultraviolet light. These methylanthracenes meet the lifetime and charge conversion criteria desired for fast light modulation. All of the methylanthracenes of the present disclosure absorb in the near-ultraviolet region, e.g., between approximately 300 nm and approximately 400 nm, but become photochromic in the visible region.

Referring to FIG. 4B, this schematic diagram illustrates a transient absorption apparatus 400, by example only, using a photoactive solution system S (FIG. 17) for at least one of a photochromic liquid and a photoconductive liquid, in accordance with embodiments of the present disclosure. The photoactive solution system S, comprising a solute, such as an anthracene derivative, and a protonating solvent comprising at least two solvents, is disposable in a cuvette, such as a sample cuvette 40. The apparatus 400 comprises a light source, such as a xenon (Xe) lamp 41, for providing a probe beam 41a, a laser source, such as an xenon fluoride (XeF) eximer laser 42, for providing an excitation beam 42a, such as a pulsed excitation beam, a monochrometer 43 for measuring a photoactive response of the system S being irradiated by the probe beam 41a while being irradiated by the excitation beam 42a (pulsed), and a digital scope 44 for sensing and measuring at least one signal, such as a photomultiplier signal 44a, the digital scope 44 configured to trigger by way of the eximer laser 42, whereby molecules of the solute are excited, and whereby a photoactive response is elicited.

Referring to FIG. 5, this diagram illustrates a numbering system for nomenclature corresponding to anthracene derivatives (AD) in accordance with embodiments of the present disclosure. Protonation likely occurs at the 9-position, or equivalent 10-position in the ground state for at least molecular orbital considerations. Upon excitation of the photoactive solution system with a pulse of near-ultraviolet light at approximately 351 nm from a XeF eximer laser (pulse width of approximately 40 nanoseconds), the photoactive solution system, involving an AD will absorb visible light (become colored). This absorption is not constant, but decreases with time, eventually returning the solution to the colorless state. Thus, this absorption is denoted “transient.” Transient absorption spectra of the protonated forms of anthracene and a number of methyl substituted anthracenes in the solvents HFIP and TFA after laser excitation at 351 nm (near ultraviolet) are observable. The methylanthracenes comprise 9-methylanthracene (9-MA), 9,10-dimethylanthracene (DMA), 2,3,6,7-tetramethyanthracene (TMA), and 1,2,4,5,6,8-hexamethylanthracene (HMA).

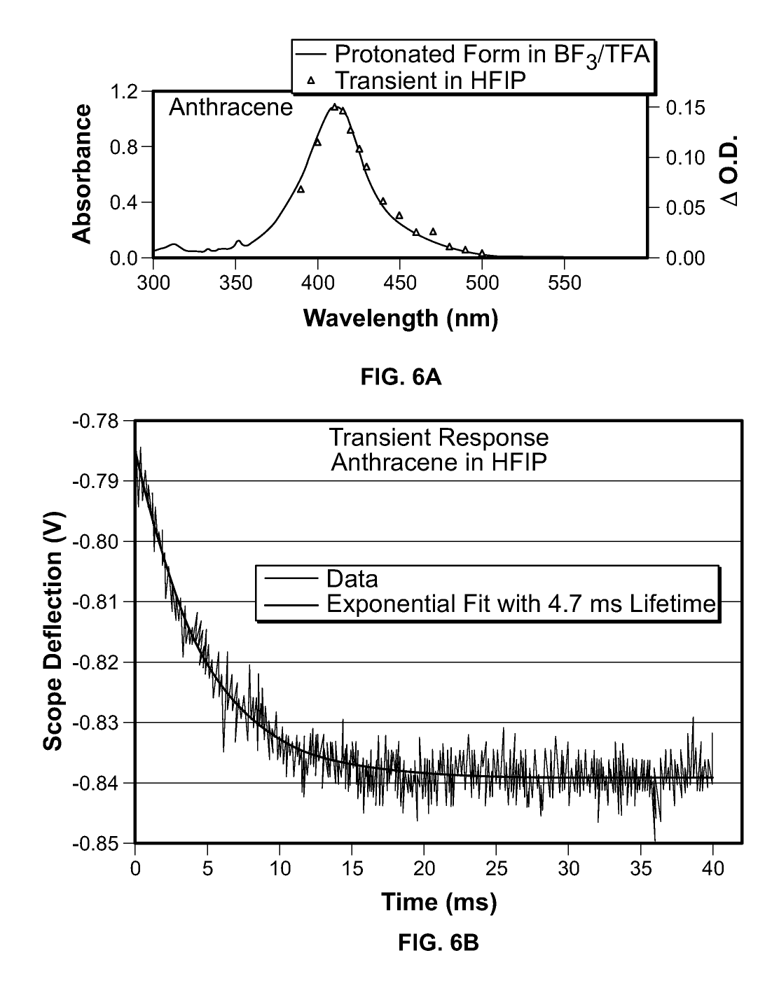

Still referring to FIG. 5 and ahead to FIGS. 6-14, some examples of transient absorption spectra are compared with the steady state absorption spectra of the associated ground state protonated forms of the molecule, e.g., an AD in strong acid (FIGS. 6-14). The transient spectra decay exponentially with lifetimes given for each molecule (FIG. 15). In FIGS. 6-14, the left y-axis represents absorbance, which is defined as minus the log to the base 10 of the intensity of the transmitted light divided by the intensity of the incident light. The left y-axis refers to steady state absorption. The right y-axis refers to the change in optical density, ΔO.D. (defined as absorbance), of the transient spectra immediately after the laser pulse. The difference in nomenclature (optical density vs. absorbance) is used to emphasize the transient nature of the spectra defined by the discrete points.

Referring to FIG. 6A, this diagram illustrates UV-visible absorption spectra of ground-state protonated anthracene in a BF₃/TFA solvent and a transient anthracene in an HFIP solvent, in accordance with embodiments of the present disclosure. In this first example, the transient anthracene in the HFIP solvent is excited with a pulse of near-ultraviolet light at approximately 351 nm from a XeF eximer laser with a pulse width of approximately 40 nanoseconds. The transient absorption spectrum is recorded (represented by triangles) and compared with the steady state absorption spectrum of the associated ground state protonated form of the molecule in the strong acid solvent, e.g., the BF₃/TFA solvent (represented by a solid curve).

Referring to FIG. 6B, this graphical diagram illustrates the transient response of anthracene in an HFIP solvent, wherein the lifetime is determined using an exponential fit to the scope data, and wherein the observed transient lifetime is approximately 5 ms, in accordance with embodiments of the present invention.

Referring to FIG. 7, this diagram illustrates UV-visible absorption spectra of a ground-state protonated anthracene in a BF₃/TFA solvent and a transient anthracene in a TFA solvent, in accordance with embodiments of the present disclosure. In this second example, the anthracene in the TFA solution is excited with a pulse of near-ultraviolet light at approximately 351 nm from a XeF eximer laser with a pulse width of approximately 40 nanoseconds. The transient absorption spectrum is recorded (triangles) and compared with the steady state absorption spectrum of the associated ground state protonated forms of the molecule in the strong acid solution, e.g., the BF₃/TFA solvent (solid curve). The observed transient lifetime is approximately 0.7 ms.

Referring to FIG. 8, this diagram illustrates UV-visible absorption spectra of a ground-state protonated 9-methylanthracene in an H₂SO₄ solvent and a transient 9-methylanthracene in an HFIP solvent, in accordance with embodiments of the present disclosure. In this third example, the 9-methylanthracene in the HFIP solvent is excited with a pulse of near-ultraviolet light at approximately 351 nm from a XeF eximer laser with a pulse width of approximately 40 nanoseconds. The transient absorption spectrum is recorded (triangles) and compared with the steady state absorption spectrum of the associated ground state protonated form of the molecule in strong acid solvent, such as the H₂SO₄ solvent (solid curve). The observed transient lifetime is approximately 6.1 ms.

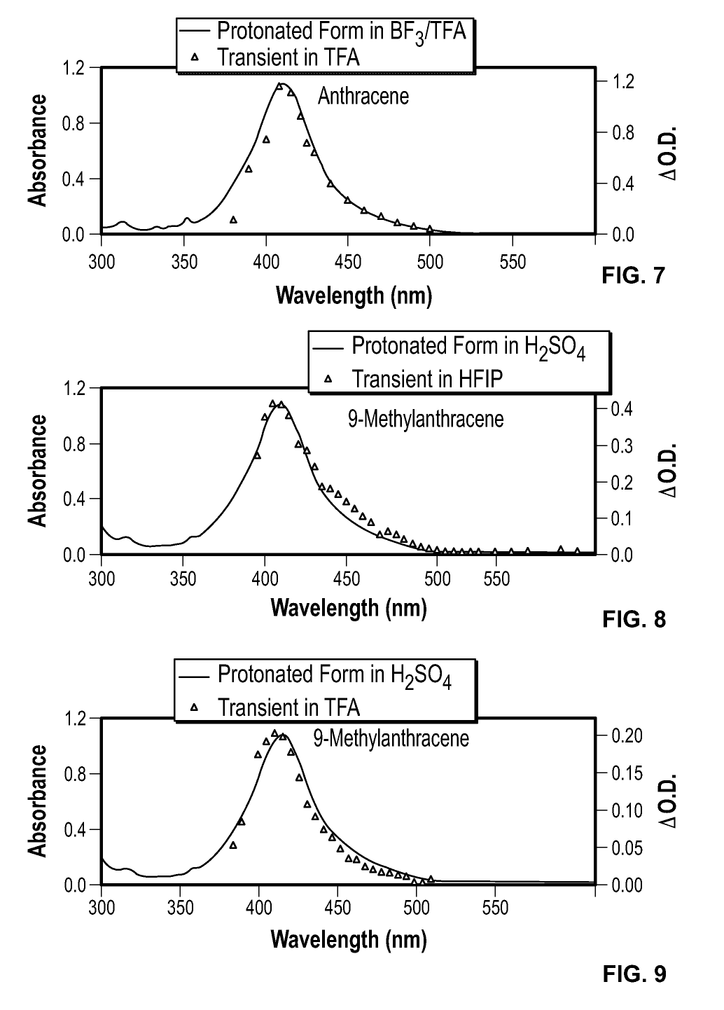

Referring to FIG. 9, this diagram illustrates UV-visible absorption spectra of a ground-state protonated 9-methylanthracene in an H₂SO₄ solvent and a transient 9-methylanthracene in a TFA solvent, in accordance with embodiments of the present disclosure. In this fourth example, the 9-methylanthracene in the TFA solvent is excited with a pulse of near-ultraviolet light at approximately 351 nm from a XeF eximer laser with a pulse width of approximately 40 nanoseconds. The transient absorption spectrum is recorded (triangles) and compared with the steady state absorption spectrum of the associated ground state protonated form of the molecule in strong acid solvent, such as the H₂SO₄ solvent (solid curve). The observed transient lifetime is approximately 2.6 ms.

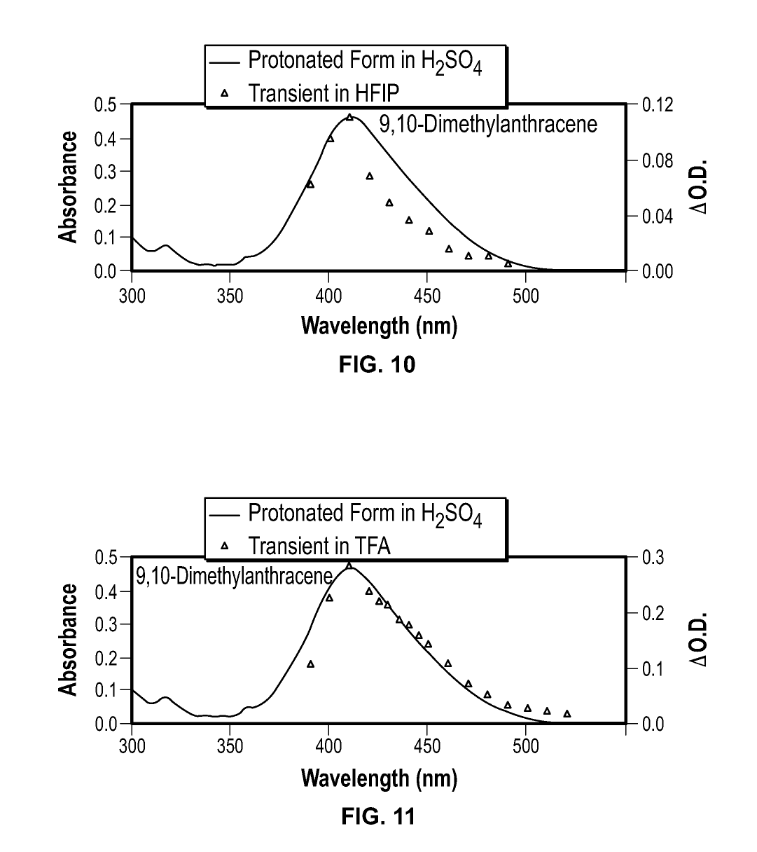

Referring to FIG. 10, this diagram illustrates UV-visible absorption spectra of a ground-state protonated 9,10-dimethylanthracene in a H₂SO₄ solvent and a transient 9,10-dimethylanthracene in an HFIP solvent, in accordance with embodiments of the present disclosure. In this fifth example, the 9,10-dimethylanthracene in the HFIP solvent is excited with a pulse of near-ultraviolet light at approximately 351 nm from a XeF eximer laser with a pulse width of approximately 40 nanoseconds. The transient absorption spectrum is recorded (triangles) and compared with the steady state absorption spectrum of the associated ground state protonated form of the molecule in the strong acid solvent, such as the H₂SO₄ solvent (solid curve). The observed transient lifetime is approximately 290 ms.

Referring to FIG. 11, this diagram illustrates UV-visible absorption spectra of a ground-state protonated 9,10-dimethylanthracene in a H₂SO₄ solvent and a transient 9,10-dimethylanthracene in a TFA solvent, in accordance with embodiments of the present disclosure. In this sixth example, the 9,10-dimethylanthracene in the HFIP solvent is excited with a pulse of near-ultraviolet light at approximately 351 nm from a XeF eximer laser with a pulse width of approximately 40 nanoseconds. The transient absorption spectrum is recorded (triangles) and compared with the steady state absorption spectrum of the associated ground state protonated form of the molecule in the strong acid solvent, such as the H₂SO₄ solvent (solid curve). The observed transient lifetime is approximately 53 ms.

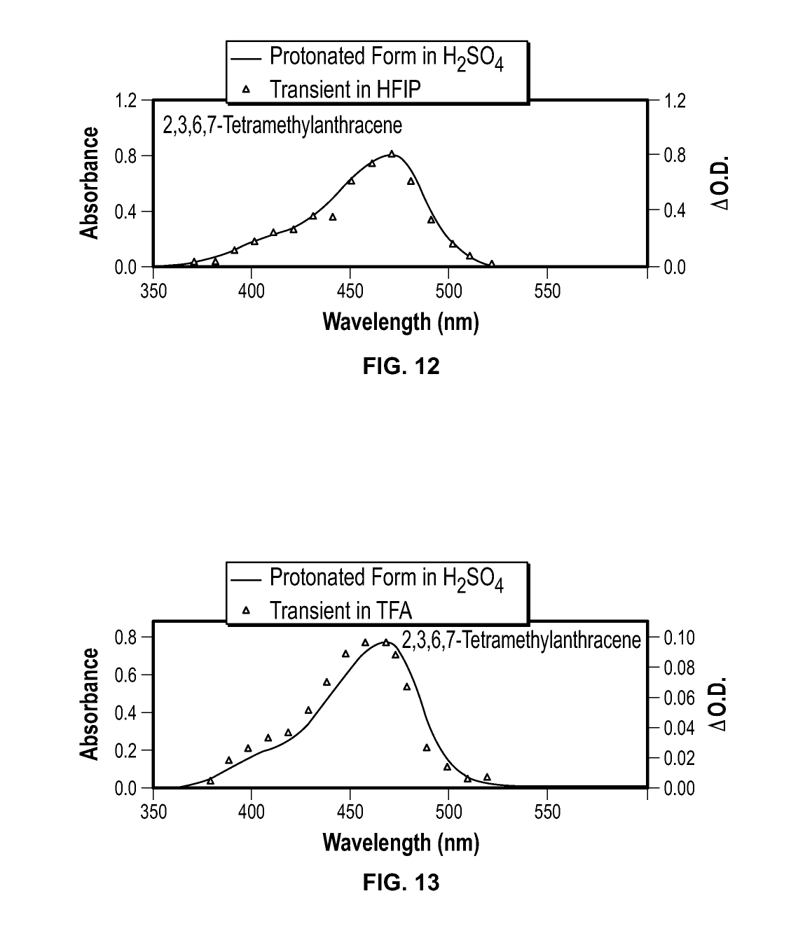

Referring to FIG. 12, this diagram illustrates UV-visible absorption spectra of a ground-state protonated 2,3,6,7-tetramethyanthracene in an H₂SO₄ solvent and a transient 2,3,6,7-tetramethyanthracene in an HFIP solvent, in accordance with embodiments of the present disclosure. In this seventh example, the 2,3,6,7-tetramethyanthracene in the HFIP solvent is excited with a pulse of near-ultraviolet light at approximately 351 nm from a XeF eximer laser with a pulse width of approximately 40 nanoseconds. The transient absorption spectrum is recorded (triangles) and compared with the steady state absorption spectrum of the associated ground state protonated form of the molecule in the strong acid solvent, such as the H₂SO₄ solvent (solid curve). The observed transient lifetime is approximately 70 ms.

Referring to FIG. 13, this diagram illustrates UV-visible absorption spectra of a ground-state protonated 2,3,6,7-tetramethyanthracene (TMA) in a H₂SO₄ solvent and a transient 2,3,6,7-tetramethyanthracene in a TFA solvent, in accordance with embodiments of the present disclosure. In this eighth example, the 2,3,6,7-tetramethyanthracene in the TFA solvent is excited with a pulse of near-ultraviolet light at approximately 351 nm from a XeF eximer laser with a pulse width of approximately 40 nanoseconds. The transient absorption spectrum is recorded (triangles) and compared with the steady state absorption spectrum of the associated ground state protonated form of the molecule in the strong acid solvent, such as the H₂SO₄ solvent (solid curve). The observed transient lifetime is approximately 14.6 ms.

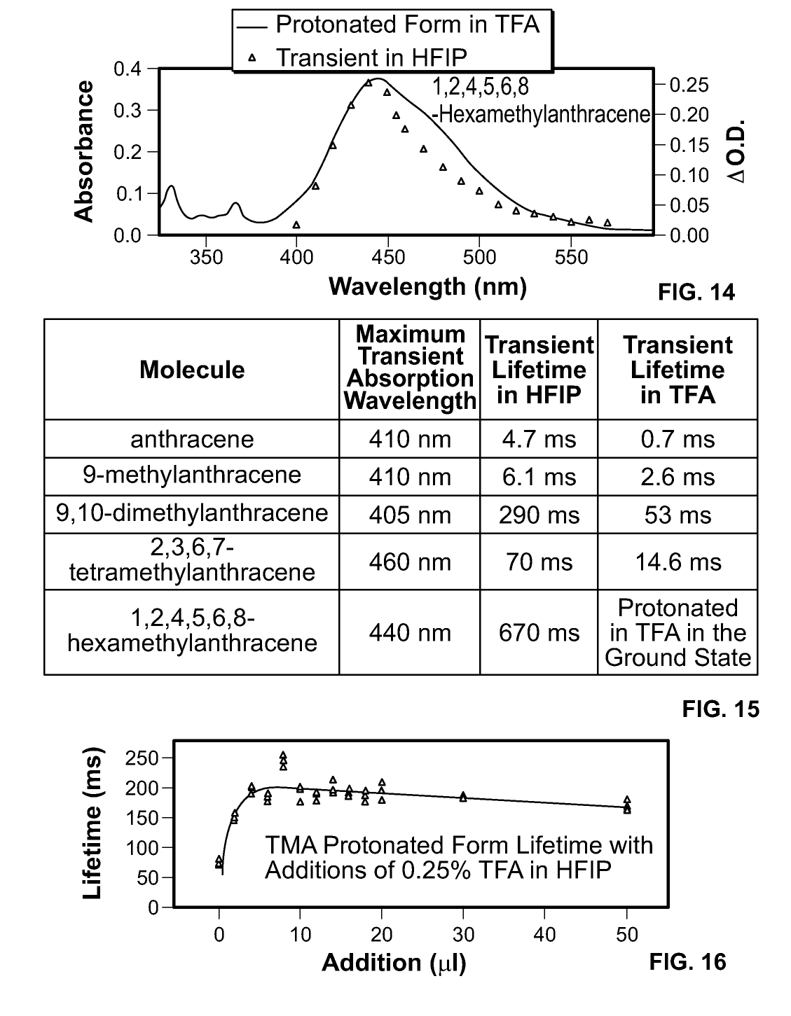

Referring to FIG. 14, this diagram illustrates UV-visible absorption spectra of a ground-state protonated 1,2,4,5,6,8-hexamethylanthracene in a TFA solvent and a transient 1,2,4,5,6,8-hexamethylanthracene in an HFIP solvent, in accordance with embodiments of the present disclosure. In this ninth example, the 1,2,4,5,6,8-hexamethylanthracene in the HFIP solvent is excited with a pulse of near-ultraviolet light at approximately 351 nm from a XeF eximer laser with a pulse width of approximately 40 nanoseconds. The transient absorption spectrum is recorded (triangles) and compared with the steady state absorption spectrum of the associated ground state protonated form of the molecule in the acid solvent, such as the TFA solvent (solid curve). The observed transient lifetime is approximately 670 ms.

Referring back to FIGS. 6-14, the transient spectra are consistent with the spectra of the ground-state protonated form in the strong acid solution with two exceptions: DMA and HMA. This circumstance indicates that the transient spectra do represent spectra of the protonated forms of the molecules. The larger long wavelength tail observed for DMA in sulfuric acid indicates a component in addition to the normal protonated form. This difference between the spectra arises from the presence of protonated DMA at a site other than usual 9-position. The bulge in longer wavelength tail for HMA arises from protonation at a second site. The transient spectra all occur largely in the visible (>˜400 nm) region of the spectrum for the photochromic materials of the photoactive systems and methods of the present disclosure.

Referring to FIG. 15, this table illustrates the wavelength at the maximum transient absorption, transient lifetime in HFIP, and transient lifetime in TFA for each of the molecules measured, in accordance with embodiments of the present disclosure. All of the molecules show transient absorption maxima in the visible spectrum. The lifetimes for the return to the colorless state are as short as approximately 0.7 ms and as long as approximately 670 ms. TMA is a particularly good photochromic candidate for at least that TMA absorbs further into the visible (approximately 460 nm) and has a lifetime of tens of milliseconds, whereby a photoactive solution system is configurable for many applications, such as in a video display device. For at least that the photochromic reactions are protonation reactions the lifetime of the visible light absorbing transient protonated form is adjustable by the controlled addition of acid to the HFIP in a solution system.

Referring to FIG. 16, this diagram illustrates the change in TMA protonated form lifetime with acid additions, such as dilute TFA in HFIP additions, in accordance with embodiments of the present disclosure. In this example, the transient protonated form of TMA in an HFIP solvent is prepared and a solution of up to approximately 0.25% volume TFA in HFIP is added drop-wise to the HFIP solvent. After each addition, the lifetime is measured. The results are plotted and displayed, showing the manner in which the lifetime of the photoactive response increases as acid (˜0.25% TFA volume in HFIP) is added to HFIP. In this manner and in like manners, the photoactive response is tunable, in accordance with embodiments of the present disclosure.

Referring to FIG. 17, this schematic diagram illustrates a photoactive solution system S for at least one of photochromic liquids and photoconductive liquids, the system S comprising: a protonating solvent 1700 comprising at least one of a first solvent 1701 and a second solvent 1702; and an anthracene-derivative (AD) solute 1703 configured to dissolve in the protonating solvent 1700, whereby a photoactive solution is responsive to light having a wavelength in at least one of a visible spectrum, a near-ultraviolet spectrum, and an ultraviolet spectrum, and whereby a photoactive response is elicitable, in accordance with an embodiment of the present disclosure. At least three solvent options are possible for the photoactive solution system S: (a) only HFIP, (b) only TFA, or (c) a combination of HFIP and TFA for fine tuning the lifetime of the photoactive response. The second solvent 1702 comprises any acid that is soluble in HFIP.

Still referring to FIG. 17, in the system S, by example only, the first solvent 1701 comprises one of 1,1,1,3,3,3-hexafluoro-2-propanol and trifluoroacetic acid. The second solvent 1702 comprises at least one of trifluoroacetic acid and any other acid soluble in 1,1,1,3,3,3-hexafluroro-2-propanol. The AD solute 1703 is selectable and comprises at least one of anthracene, 9-methylanthracene, 9,10-dimethylanthracene, 2,3,6,7-tetramethylanthracene, and 1,2,4,5,6,8-hexamethylanthracene, whereby the photoactive response comprises a tunable lifetime in a range of approximately 0.7 ms to approximately 670 ms. In the system S, the second solvent comprises a variable acid concentration in a range of up to approximately 25% volume, preferably in a range of approximately 0% to approximately 0.0042% volume, whereby the photoactive response comprises a tunable lifetime in a range of approximately 4.7 ms to approximately 290 ms, corresponding to the variable acid concentration. The tunable lifetime is also a function of the selectable anthracene-derivative (AD) solute comprising at least one of anthracene, 9-methylanthracene, 9,10-dimethylanthracene, and 2,3,6,7-tetramethylanthracene.

Still referring to FIG. 17, the system S, involves many embodiments, such as an anthracene/TFA solute/solvent system, that allows anthracene to become photo-protonated with ultraviolet light, wherein a transient lifetime of anthracene in TFA is approximately 0.7 milliseconds; an anthracene/HFIP solute/solvent system that allows anthracene to become photo-protonated with ultraviolet light, wherein a transient lifetime of anthracene in HFIP is approximately 4.7 milliseconds; a 9-methylanthracene/TFA solute/solvent system that allows 9-methylanthracene to become photo-protonated with ultraviolet light, wherein a transient lifetime of 9-methylanthracene in TFA is approximately 2.6 milliseconds; a 9-methylanthracene/HFIP solute/solvent system that allows 9-methylanthracene to become photo-protonated with ultraviolet light, wherein a transient lifetime of 9-methylanthracene in HFIP is approximately 6.1 milliseconds; a 9,10-dimethylanthracene/TFA solute/solvent system that allows 9,10-dimethylanthracene to become photo-protonated with ultraviolet light, wherein a transient lifetime of 9,10-dimethylanthracene in TFA is approximately 53 milliseconds; a 9,10-dimethylanthracene/HFIP solute/solvent system that allows 9,10-dimethylanthracene to become photo-protonated with ultraviolet light, wherein a transient lifetime of 9,10-dimethylanthracene in HFIP is approximately 290 milliseconds; a 2,3,6,7-tetramethylanthracene/TFA solute/solvent system that allows 2,3,6,7-tetramethylanthracene to become photo-protonated with ultraviolet light, wherein a transient lifetime of 2,3,6,7-tetramethylanthracene in TFA is approximately 14.6 milliseconds; a 2,3,6,7-tetramethylanthracene/HFIP solute/solvent system that allows 2,3,6,7-tetramethylanthracene to become photo-protonated with ultraviolet light, wherein a transient lifetime of 2,3,6,7-tetramethylanthracene in HFIP is approximately 70 milliseconds; a 1,2,4,5,6,8-hexamethylanthracene/HFIP solute/solvent system that allows 1,2,4,5,6,8-hexamethylanthracene to become photo-protonated with ultraviolet light, wherein a transient lifetime of 1,2,4,5,6,8-hexamethylanthracene in HFIP is approximately 670 milliseconds; and a method of selectively lengthening the lifetime of the colored state, e.g., as described in relation to the foregoing systems by adding a second solvent.

Referring to FIG. 18, this flow diagram illustrates a method M1 of preparing a photoactive solution system S (FIG. 17) for at least one of a photochromic liquid and a photoconductive liquid, in accordance with an embodiment of the present disclosure. The method M1 comprises: providing a protonating solvent, as indicated by block 1801, providing the protonating solvent 1700 comprising at least one of: providing a first solvent 1701, as indicated by block 1802; providing a second solvent 1702, as indicated by block 1803; and admixing the second solvent 1702 with the first solvent 1701, as indicated by block 1804; providing an AD solute 1703, as indicated by block 1805; and dissolving the AD solute 1703 in the protonating solvent 1700, as indicated by block 1806, thereby preparing a photoactive solution responsive to light having a wavelength in at least one of a visible spectrum, a near-ultraviolet spectrum, and an ultraviolet spectrum.

Still referring to FIG. 18, in the method M1, providing the first solvent comprises providing one of 1,1,1,3,3,3-hexafluoro-2-propanol and trifluoroacetic acid, providing the second solvent comprises providing at least one of trifluoroacetic acid and any other acid soluble in 1,1,1,3,3,3-hexafluoro-2-propanol, and providing the anthracene-derivative (AD) solute comprises providing at least one of anthracene, 9-methylanthracene, 9,10-dimethylanthracene, 2,3,6,7-tetramethylanthracene, and 1,2,4,5,6,8-hexamethylanthracene. Further, in the method M1, providing the second solvent comprises providing a variable acid concentration in a range of approximately 0% to approximately 25% volume, preferably in a range of approximately 0% to approximately 0.0042% volume, whereby the photoactive response comprises a tunable lifetime in a range of approximately 4.7 ms to approximately 290 ms, corresponding to the variable acid concentration. By example only, the first solvent comprises HFIP; and the second solvent comprises both TFA and HFIP, wherein approximately 50 μl of 0.25% TFA in HFIP is added to approximately 3 ml of HFIP, whereby the protonating solvent is provided.

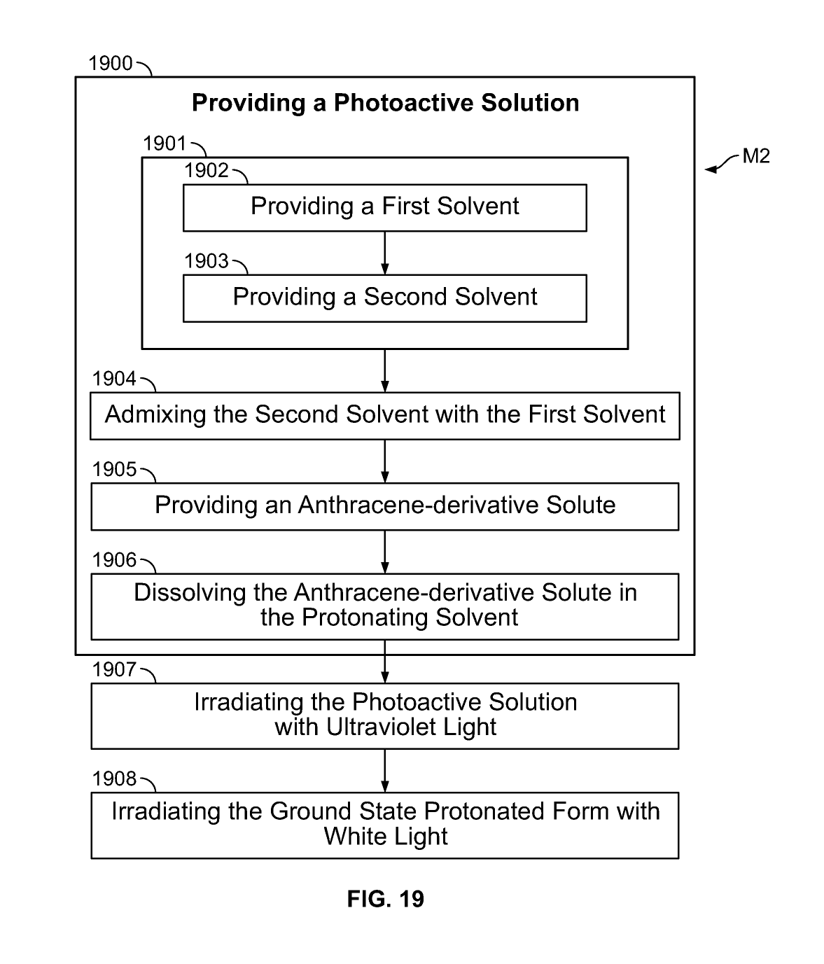

Referring to FIG. 19, this flow diagram illustrates a method M2 of eliciting a photoactive response by way of a photoactive solution system for at least one of a photochromic liquid and a photoconductive liquid, in accordance with an embodiment of the present disclosure. The method M2 comprises: providing a photoactive solution, as indicated by block 1900, providing the photoactive solution comprising: providing a protonating solvent 1700 (FIG. 17), providing the protonating solvent 1700 comprising at least one of: providing a first solvent 1701, as indicated by block 1902; providing a second solvent 1702, as indicated by block 1903; and admixing the second solvent 1702 with the first solvent 1701, as indicated by block 1904; providing an AD solute 1703, as indicated by block 1905; and dissolving the AD solute 1703 in the protonating solvent 1700, as indicated by block 1906, thereby preparing a photoactive solution responsive to light having a wavelength in at least one of a visible spectrum, a near-ultraviolet spectrum, and an ultraviolet spectrum; and irradiating the photoactive solution with ultraviolet light, as indicated by block 1907, thereby eliciting the photoactive response.

Still referring to FIG. 19, in the method M2, providing the first solvent comprises providing one of 1,1,1,3,3,3-hexafluoro-2-propanol and trifluoroacetic acid, providing the second solvent comprises providing at least one of trifluoroacetic acid and any other acid soluble in 1,1,1,3,3,3-hexafluoro-2-propanol, and providing the anthracene-derivative (AD) solute comprises selectively providing at least one of anthracene, 9-methylanthracene, 9,10-dimethylanthracene, 2,3,6,7-tetramethylanthracene, and 1,2,4,5,6,8-hexamethylanthracene. Further, in the method M2, providing the second solvent comprises providing a variable acid concentration in a range of up to approximately 25% volume, preferably in a range of approximately 0% to approximately 0.0042% volume, whereby the photoactive response comprises a tunable lifetime in a range of approximately 4.7 ms to approximately 290 ms, corresponding to the variable acid concentration. The tunable lifetime is a function of the selectable anthracene-derivative (AD) solute.

Still referring to FIG. 19, in the method M2, irradiating the photoactive solution with ultraviolet light, as indicated by block 1907, comprises irradiating the photoactive solution system with an eximer laser (in the near-UV spectrum, e.g., at a wavelength of approximately 351 nm), e.g., by pulsing to produce an excited state B* in the solute, in accordance with an embodiment of the present disclosure. The method M2 further comprises continuously irradiating the photoactive solution system with a Xe lamp (white light) 1908; measuring, by scanning, throughput of white light by a monochrometer, thereby determining absorbance at a particular wavelength; transmitting the white light throughput to a photomultiplier, thereby providing a scope decay curve; fitting the scope decay curve to an exponential function, thereby providing a fitted curve, determining an amplitude of the fitted curve; and, using the amplitude of fitted curve, calculating an absorbance value at the particular wavelength; and returning to the measuring step for another particular wavelength until the measuring step has been performed for all particular wavelengths of interest, whereby an absorption spectrum is obtained, and whereby the absorption spectrum of the solute is compared with that of the ground-state protonated form of the solute.

Still referring to FIG. 19, in the method M2, irradiating the photoactive solution with ultraviolet light, as indicated by block 1907, comprises irradiating the photoactive solution system with near-UV light, in accordance with an alternative embodiment of the present disclosure. In this embodiment, the method M2 further comprises irradiating the photoactive solution system with visible light; measuring, by scanning, throughput of white light by a monochrometer, thereby determining absorbance at a particular wavelength; transmitting the white light throughput to a photomultiplier, thereby providing a scope decay curve; fitting the scope decay curve to an exponential function, thereby providing a fitted curve, determining an amplitude of the fitted curve; and, using the amplitude of fitted curve, calculating an absorbance value at the particular wavelength; and returning to the step of irradiating the photoactive solution system with near-UV light until the irradiating step has been performed for all particular wavelengths of interest, whereby an absorption spectrum is obtained, and whereby the absorption spectrum of the solute is compared with that of the ground-state protonated form of the solute.

Understood is that many additional changes in the details, materials, substances, species, steps and arrangement of parts, which have been herein described and illustrated to explain the nature of the present disclosure, may be made within the principle and scope of the present disclosure as expressed in the appended claims.

1. A photoactive solution system for at least one of photochromic liquids and photoconductive liquids, comprising:
a protonating solvent comprising at least one of a first solvent, wherein the first solvent comprises one of 1,1,1,3,3,3-hexafluoro-2-propanol and trifluoroacetic acid, and a second solvent, wherein the second solvent comprises at least one of trifluoroacetic acid and any other acid soluble in 1,1,1,3,3,3-hexafluoro-2-propanol,
an anthracene-derivative solute configured to dissolve in the protonating solvent,
whereby a photoactive solution is responsive to light having a wavelength in at least one of a visible spectrum, a near-ultraviolet spectrum, and an ultraviolet spectrum, and
whereby a photoactive response is elicitable.

2. The system of claim 1, wherein the first solvent comprises one of 1,1,1,3,3,3-hexafluoro-2-propanol and trifluoroacetic acid.

3. The system of claim 1, wherein the second solvent comprises at least one of trifluoroacetic acid and any other acid soluble in 1,1,1,3,3,3-hexafluoro-2-propanol.

4. The system of claim 1, wherein the anthracene-derivative solute is selectable and comprises at least one compound chosen from anthracene, 9-methylanthracene, 9,10-dimethylanthracene, 2,3,6,7-tetramethylanthracene, or 1,2,4,5,6,8-hexamethylanthracene.

5. The system of claim 1,
wherein the first solvent comprises 1,1,1,3,3,3-hexafluoro-2-propanol,
wherein the second solvent comprises trifluoroacetic acid, and
wherein the anthracene-derivative solute is selectable and comprises at least one compound chosen from anthracene, 9-methylanthracene, 9,10-dimethylanthracene, 2,3,6,7-tetramethylanthracene, or 1,2,4,5,6,8-hexamethylanthracene.

6. The system of claim 2,
wherein the first solvent comprises trifluoroacetic acid,
wherein the photoactive response comprises a tunable lifetime in a range of at least or approximately 0.7 ms, corresponding to the anthracene-derivative solute comprising anthracene,
wherein the photoactive response comprises a tunable lifetime in a range of at least or approximately 2.6 ms, corresponding to the anthracene-derivative solute comprising 9-methylanthracene,
wherein the photoactive response comprises a tunable lifetim e in a range of at least or approximately 53 ms, corresponding to the anthracene-derivative solute comprising 9,10-dimethylanthracene, and
wherein the photoactive response comprises a tunable lifetime in a range of at least or approximately 14.6 ms, corresponding to the anthracene-derivative solute comprising 2,3,6,7-tetramethylanthracene.

7. The system of claim 2,
wherein the first solvent comprises 1,1,1,3,3,3-hexafluoro-2-propanol,
wherein the photoactive response comprises a tunable lifetime in a range of at least or approximately 4.7 ms, corresponding to the anthracene-derivative solute comprising anthracene,
wherein the photoactive response comprises a tunable lifetime in a range of at least or approximately 6.1 ms, corresponding to the anthracene-derivative solute comprising 9-methylanthracene,
wherein the photoactive response comprises a tunable lifetime in a range of at least or approximately 290 ms, corresponding to the anthracene-derivative solute comprising 9,10-dimethylanthracene,
wherein the photoactive response comprises a tunable lifetime in a range of at least or approximately 70 ms, corresponding to the anthracene-derivative solute comprising 2,3,6,7-tetramethylanthracene, and
wherein the photoactive response comprises a tunable lifetime in a range of at least or approximately 670 ms, corresponding to the anthracene-derivative solute comprising 1,2,4,5,6,8-hexamethylanthracene.

8. The system of claim 4,
wherein the second solvent comprises a variable acid concentration in a range of approximately 0% to approximately 25% volume,
wherein the photoactive response comprises a tunable lifetime in a range of approximately 4.7 to approximately 290 ms, and
wherein the tunable lifetime is a function of the selectable anthracene-derivative solute.

9. The system of claim 1,
wherein the first solvent comprises 1,1,1,3,3,3-hexafluoro-2-propanol,
wherein the second solvent comprises trifluoroacetic acid,
wherein the anthracene-derivative solute comprises 2,3,6,7-tetramethylanthracene,
wherein the second solvent comprises a variable acid concentration in a range of approximately 0% to approximately 0.0042% volume, and
wherein the photoactive response comprises a tunable lifetime in a range of approximately 70 ms to approximately 250 ms corresponding to the variable acid concentration.

10. A method of formulating a photoactive solution system for at least one of photochromic liquids and photoconductive liquids, comprising:
providing a protonating solvent comprising at least one of providing a first solvent and providing a second solvent; and
providing an anthracene-derivative solute configured to dissolve in the protonating solvent,
whereby a photoactive solution is responsive to light having a wavelength in at least one of a visible spectrum, a near-ultraviolet spectrum, and an ultraviolet spectrum, and
whereby a photoactive response is elicitable.

11. The method of claim 10, wherein providing the first solvent comprises providing one of 1,1,1,3,3,3-hexafluoro-2-propanol and trifluoroacetic acid.

12. The method of claim 10, wherein providing the second solvent comprises providing at least one of trifluoroacetic acid and any other acid soluble in 1,1,1,3,3,3-hexafluoro-2-propanol.

13. The method of claim 10, wherein providing the anthracene anthracene-derivative solute comprises selectively providing at least one of anthracene, 9-methylanthracene, 9,10-dimethylanthracene, 2,3,6,7-tetramethylanthracene, and 1,2,4,5,6,8-hexamethylanthracene.

14. The method of claim 10,
wherein providing the first solvent comprises providing 1,1,1,3,3,3-hexafluoro-2-propanol,
wherein providing the second solvent comprises providing trifluoroacetic acid, and
wherein providing the anthracene-derivative solute comprises selectively providing at least one of anthracene, 9-methylanthracene, 9,10-dimethylanthracene, 2,3,6,7-tetramethylanthracene, and 1,2,4,5,6,8-hexamethylanthracene.

15. The method of claim 11,
wherein providing the first solvent comprises providing trifluoroacetic acid,
wherein the photoactive response comprises a tunable lifetime in a range of at least approximately 0.7 ms, corresponding to the anthracene-derivative solute comprising anthracene,
wherein the photoactive response comprises a tunable lifetime in a range of at least approximately 2.6 ms, corresponding to the anthracene-derivative solute comprising 9-methylanthracene,
wherein the photoactive response comprises a tunable lifetime in a range of at least approximately 53 ms, corresponding to the anthracene-derivative solute comprising 9,10-dimethylanthracene, and
wherein the photoactive response comprises a tunable lifetime in a range of at least approximately 14.6 ms, corresponding to the anthracene-derivative solute comprising 2,3,6,7-tetramethylanthracene.

16. The method of claim 11,
wherein providing the first solvent comprises providing 1,1,1,3,3,3-hexafluoro-2-propanol,
wherein the photoactive response comprises a tunable lifetime in a range of at least approximately 4.7 ms, corresponding to the anthracene-derivative solute comprising anthracene,
wherein the photoactive response comprises a tunable lifetime in a range of at least approximately 6.1 ms, corresponding to the anthracene-derivative solute comprising 9-methylanthracene,
wherein the photoactive response comprises a tunable lifetime in a range of at least approximately 290 ms, corresponding to the anthracene-derivative solute comprising 9,10-dimethylanthracene,
wherein the photoactive response comprises a tunable lifetime in a range of at least approximately 70 ms, corresponding to the anthracene-derivative solute comprising 2,3,6,7-tetramethylanthracne, and
wherein the photoactive response comprises a tunable lifetime in a range of at least approximately 670 ms, corresponding to the anthracene-derivative solute comprising 1,2,4,5,6,8-hexamethylanthracene.

17. The method of claim 13,
wherein providing the second solvent comprises providing a variable acid concentration in a range of approximately 0% to approximately 25% volume,
wherein the photoactive response comprises a tunable lifetime in a range of approximately 4.7 to approximately 290 ms, and
wherein the tunable lifetime is a function of the selectable anthracene-derivative solute.

18. The method of claim 10,
wherein providing the first solvent comprises providing 1,1,1,3,3,3-hexafluoro-2-propanol,
wherein providing the second solvent comprises providing trifluoroacetic acid,
wherein providing the anthracene-derivative solute comprises providing 2,3,6,7-tetramethylanthracene,
wherein providing the second solvent comprises providing a variable acid concentration in a range of approximately 0% to approximately 0.0042% volume, and
wherein the photoactive response comprises a tunable lifetime in a range of approximately 70 ms to approximately 250 ms corresponding to the variable acid concentration.

19. A method of eliciting a photoactive response by way of a photoactive solution system for at least one of photochromic liquids and photoconductive liquids, the method comprising:
providing a photoactive solution, providing the photoactive solution comprising providing a protonating solvent comprising at least one of providing a first solvent and providing a second solvent; and providing an anthracene-derivative solute configured to dissolve in the protonating solvent, whereby a photoactive solution is responsive to light having a wavelength in at least one of a visible spectrum, a near-ultraviolet spectrum, and an ultraviolet spectrum, and whereby a photoactive response is elicitable;
dissolving the anthracene-derivative solute in the protonating solvent, thereby preparing a photoactive solution responsive to light having a wavelength in at least one of a visible spectrum, a near-ultraviolet spectrum, and an ultraviolet spectrum; and
irradiating the photoactive solution with ultraviolet light, thereby eliciting the photoactive response.

20. The method of claim 19,
wherein providing the first solvent comprises providing 1,1,1,3,3,3-hexafluoro-2-propanol,
wherein providing the second solvent comprises providing trifluoroacetic acid,
wherein providing the anthracene derivative comprises providing 2,3,6,7-tetramethylanthracene,
wherein providing the second solvent comprises providing a variable acid concentration in an range of approximately 0% to approximately 0.0042% volume, and
whereby the photoactive response comprises a tunable lifetime in a range of approximately 70 ms to approximately 250 ms corresponding to the variable acid concentration.
